(19) United States
(12) Patent Application Publication
(10) Pub. No.: US 2025/0307023 A1
(43) Pub. Date: Oct. 2, 2025

(54) DYNAMIC SENSOR SELECTION

(71) Applicant: LENOVO (SINGAPORE) PTE. LTD., SINGAPORE (SG)

(72) Inventors: Robert J. Kapinos, Morrisville, NC (US); Scott Li, Morrisville, NC (US); Robert James Norton, JR., Morrisville, NC (US)

(21) Appl. No.: 18/621,595

(22) Filed: Mar. 29, 2024

(51) Int. Cl. G06F 9/46; G06F 9/50

(52) U.S. Cl. CPC G06F 9/5066; G06F 9/5094; G06F 9/541; G06F 2209/501; G06F 2209/503

(57) ABSTRACT

In one aspect, a device includes a processor system and storage with instructions executable by the processor system. The instructions are executable to identify sensors that are available to provide sensor input, and to identify a sensor data request from an application (app). The instructions are also executable to, based on the sensors that are available and based on the sensor data request, select a first sensor as a selected sensor from which to source uncooked data to meet the sensor data request. The instructions are also executable to receive the uncooked data from the first sensor and to, based on the selection, execute a shim to cook the uncooked data from the first sensor into cooked data. The instructions are then executable to provide the cooked data to the app and represent to the app that the cooked data is from the second sensor.

### FIELD

The disclosure below relates to technically inventive, non-routine solutions that are necessarily rooted in computer technology and that produce concrete technical improvements. In particular, the disclosure below relates to techniques for dynamic sensor selection in electronic devices.

### BACKGROUND

As recognized herein, various sensors on a computing device might overlap in function. For example, human presence detection (HPD) may be executed using input from a camera, a radar sensor, a microphone, or a heat sensor. As also recognized herein, sensor data can satisfy more than one need. For example, a microphone can be used to acquire audio, execute HPD, and determine user distance.

However, currently, each application (“app”) that needs sensor data to operate goes and selects whatever sensor it is preprogrammed to select for its operations. Present principles recognize that this is not always optimal for overall operation of the computing device, given other constraints on the computing device as well as the available computing resources. There are currently no adequate solutions to the foregoing computer-related, technological problem.

### SUMMARY

Accordingly, in one aspect a device includes a processor system, a first sensor of a first sensor type, a second sensor of a second sensor type different from the first sensor type, and storage accessible to the processor system. The storage includes instructions executable by the processor system to identify one or more sensors that are available to provide sensor input to the processor system, and to identify a sensor data request from an application (app) executable by the processor system. The instructions are also executable to dynamically select, based on the one or more sensors that are available and based on the sensor data request, the first sensor over the second sensor as a selected sensor from which to source uncooked data to meet the sensor data request. The instructions are then executable to receive the uncooked data from the first sensor and to, based on the dynamic selection, execute a shim to cook the uncooked data from the first sensor into cooked data. The instructions are also executable to provide the cooked data to the app and also represent to the app that the cooked data is sourced from the second sensor.

In various example embodiments, the dynamic selection may be based on one or more persistent system policies. The dynamic selection may also be based on one or more transient system states, such as a current power state of the device and/or a current usage of one or more processors in the processor system. If desired, the dynamic selection may also be based on one or more user preferences accessible to the device. The user preferences may be overridable by the one or more persistent system policies and/or the one or more transient system states.

Additionally or alternatively, in some example implementations the dynamic selection may be based on both of computing resource metrics expected based on operation of the first sensor to meet the sensor data request, and computing resource metrics expected based on operation of the second sensor to meet the sensor data request. The computing resource metrics may relate to expected power to be consumed by each of the first sensor and the second sensor to meet the sensor data request, and/or may relate to expected processor resources to be consumed by each of the first sensor and the second sensor to meet the sensor data request. In addition to or in lieu of that, the computing resource metrics may relate to data time-to-delivery using each of the first sensor and the second sensor to meet the sensor data request.

Also in certain example implementations, the dynamic selection may be based on the combination of data cooking steps that best achieves the plurality of sensor data requests received from applications.

In another aspect, a method includes identifying one or more sensors that are available to provide sensor input to a processor system and also identifying a sensor data request from an application (app) executable by the processor system. The method further includes using the processor system to select, based on the one or more sensors that are available and based on the sensor data request, a first sensor as a selected sensor from which to source uncooked data to meet the sensor data request. The method also includes receiving, at the processor system, the uncooked data from the first sensor. The method then includes, based on the selection, using the processor system to execute a shim to cook the uncooked data from the first sensor into cooked data. The method then includes using the processor system to provide the cooked data to the app.

In some examples, the method may also include using the processor system to represent to the app that the cooked data is sourced from a second sensor different from the first sensor.

Further, if desired, the method may include, based on one or more criteria for the selection, selecting one of a first processor and a second processor to cook the uncooked data. The first and second processors may be processors of different processor types (e.g., one is a GPU and one is a CPU, one is a CPU and one is a co-processor consuming less power but having less processing capability, etc.).

Also in some examples, the app may be a first app, the sensor data request may be a first sensor data request, the uncooked data may be first uncooked data, the cooked data may be first cooked data, and the shim may be a first shim. According to these examples, the method may further include, while providing the first cooked data to the first app, identifying a second sensor data request from a second app executable by the processor system. Here the method may then include using the processor system to select, based on the one or more sensors that are available and based on the second sensor data request, a third sensor as a selected sensor from which to source second uncooked data to meet the first sensor data request and from which to concurrently source third uncooked data to meet the second sensor data request. Also according to these examples, the method may include receiving, at the processor system, the second uncooked data from the third sensor and receiving, at the processor system, the third uncooked data from the third sensor. The method may then include using the processor system to execute a second shim to cook the second uncooked data from the third sensor into second cooked data. The method may also include using the processor system to execute a third shim to cook the third uncooked data from the third sensor into third cooked data. From there the method may include using the processor system to provide the second cooked data to the first app and to provide the third cooked data to the second app.

In various example implementations, the second shim may be different from first shim. In certain specific examples, the first, second, and third shims may all be different from each other. Still further, if desired, the third sensor may be different from the first sensor and may be different from the second sensor.

In still another aspect, at least one computer readable storage medium (CRSM) that is not a transitory signal includes instructions executable by a processor system. The instructions are executable to identify one or more sensors that are available to provide sensor input to the processor system, and to identify a sensor data request from an application (app) executable by the processor system. The instructions are also executable to select, based on the one or more sensors that are available and based on the sensor data request, a first sensor as a selected sensor from which to source uncooked data to meet the sensor data request. The instructions are further executable to receive the uncooked data from the first sensor and to, based on the selection, execute a shim to cook the uncooked data from the first sensor into cooked data. The instructions are then executable to provide the cooked data to the app.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system consistent with present principles;

FIG. 2 is a schematic diagram of example software architecture consistent with present principles;

FIG. 3 illustrates example logic in example flow chart format that may be executed by a device consistent with present principles; and

FIGS. 4 and 5 show different graphical user interfaces (GUIs) that may be presented on a display consistent with present principles.

### DETAILED DESCRIPTION

Among other things, the detailed description below recognizes that artificial intelligence (AI) and other post-processing makes single sensors capable of serving more than one purpose. However, power requirements may make some sensors more preferable than others, as may certain performance requirements. Additionally, user workflows might make some sensors more preferable than others. With this in mind, principles below discuss a multi-level system architecture to handle sensor arbitration.

The architecture may include sensor drivers to gather analog data and present the analog data to a device's software stack as digital data. The architecture may also include hardware co-processors such as digital signal processors (DSPs) and/or image signal processors (ISPs) that may perform dedicated transformations and/or cook digital data. Thus, software components may use a central processing unit (CPU) to perform dedicated transformations and/or cook digital data, as may software shims that perform transformations on digital data.

The architecture may also include hooks into the system driver layer to determine the available sensors and the available data that can be directly extracted. An input layer may then provide, potentially based on user input, the current system state, the system policies, and innate knowledge of sensor costs, current sensor needs, and direction as to the priority of sensor attributes.

A decision module may then be used to choose the set of sensors to operate based on the output from the analysis and input layers. An execution module can then be brought in, dynamically controlling shims, sensors, co-processors, and software components so that at any given time the best match to the decision layer parameters may be met.

Thus, for example, a minimum set/number of sensors may be turned on while unneeded sensors are turned off. Concurrently, unneeded software may also not be loaded, and unneeded co-processors may be turned off or freed for other uses. Thus, present principles may help to reduce power consumption, heat production, and noise production.

Accordingly, in one aspect, analog data such as raw data gathered from the environment (e.g., image pixels, sound waves, or time of flight reflections) may be processed using a co-processor or CPU. The coprocessor may be a dedicated chip or circuit that takes work from the CPU and performs it more efficiently, while the CPU may be a general purpose computing unit that is capable of doing any sort of possible operation. The analog data may be cooked by, e.g., turning data unsuitable for a task into data suitable for the task. Cooked data may therefore be, in some non-limiting examples, relative to the task. For example, a camera image may be cooked data for user viewing on a display, and uncooked data for face tracking. The cooked data may thus be more generally digital data that is formatted usefully to do a given, particular task.

Sensor drivers as discussed further below may be established by software components that gather digital measurements from a sensor and report them to other parts of the computer system. Other kinds of drivers may also be used consistent with present principles.

Digital signal processors (DSPs) may also be used for analyzing audio waves consistent with present principles, while image signal processors (ISPs) may be used for turning capture pixels into a digital video frame consistent with present principles.

In certain non-limiting examples, raw data as referenced below may be digital data as it comes out of a driver, even if generally unsuitable for app-specific tasks. The raw data itself may be gathered by a sensor hardware component that gathers analog data and reports digital measurements.

A shim as described below may be, in non-limiting implementations, a software component responsible for matching data formats between one component and another.

Prior to delving further into the details of the instant techniques, note with respect to any computer systems discussed herein that a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple Inc. of Cupertino CA, Google Inc. of Mountain View, CA, or Microsoft Corp. of Redmond, WA. A Unix® or similar such as Linux® operating system may be used, as may a Chrome or Android or Windows or macOS operating system. These operating systems can execute one or more browsers such as a browser made by Microsoft or Google or Mozilla or another browser program that can access web pages and applications hosted by Internet servers over a network such as the Internet, a local intranet, or a virtual private network.

As used herein, instructions refer to computer-implemented steps for processing information in the system. Instructions can be implemented in software, firmware or hardware, or combinations thereof and include any type of programmed step undertaken by components of the system; hence, illustrative components, blocks, modules, circuits, and steps are sometimes set forth in terms of their functionality.

A processor may be any single- or multi-chip processor that can execute logic by means of various lines such as address lines, data lines, and control lines and registers and shift registers. Moreover, any logical blocks, modules, and circuits described herein can be implemented or performed with a system processor such as a central processing unit (CPU), a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can also be implemented by a controller or state machine or a combination of computing devices. Thus, the methods herein may be implemented as software instructions executed by a processor, suitably configured application specific integrated circuits (ASIC) or field programmable gate array (FPGA) modules, or any other convenient manner as would be appreciated by those skilled in the art. Where employed, the software instructions may also be embodied in a non-transitory device that is being vended and/or provided, and that is not a transitory, propagating signal and/or a signal per se. For instance, the non-transitory device may be or include a hard disk drive, solid state drive, or CD ROM. Flash drives may also be used for storing the instructions. Additionally, the software code instructions may also be downloaded over the Internet (e.g., as part of an application (“app”) or software file). Accordingly, it is to be understood that although a software application for undertaking present principles may be vended with a device such as the system 100 described below, such an application may also be downloaded from a server to a device over a network such as the Internet. An application can also run on a server and associated presentations may be displayed through a browser (and/or through a dedicated companion app) on a client device in communication with the server.

Software modules and/or applications described by way of flow charts and/or user interfaces herein can include various sub-routines, procedures, etc. Without limiting the disclosure, logic stated to be executed by a particular module can be redistributed to other software modules and/or combined together in a single module and/or made available in a shareable library. Also, the user interfaces (UI)/graphical UIs described herein may be consolidated and/or expanded, and UI elements may be mixed and matched between UIs.

Logic when implemented in software, can be written in an appropriate language such as but not limited to hypertext markup language (HTML)-5, Java®/JavaScript, C # or C++, and can be stored on or transmitted from a computer-readable storage medium such as a hard disk drive (HDD) or solid state drive (SSD), a random access memory (RAM), read-only memory (ROM), electrically erasable programmable read-only memory (EEPROM), a hard disk drive or solid state drive, compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

The term “a” or “an” in reference to an entity refers to one or more of that entity. As such, the terms “a” or “an”, “one or more”, and “at least one” can be used interchangeably herein.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

The term “circuit” or “circuitry” may be used in the summary, description, and/or claims. The term “circuitry” includes all levels of available integration, e.g., from discrete logic circuits to the highest level of circuit integration such as VLSI, and includes programmable logic components programmed to perform the functions of an embodiment as well as processors (e.g., special-purpose processors) programmed with instructions to perform those functions.

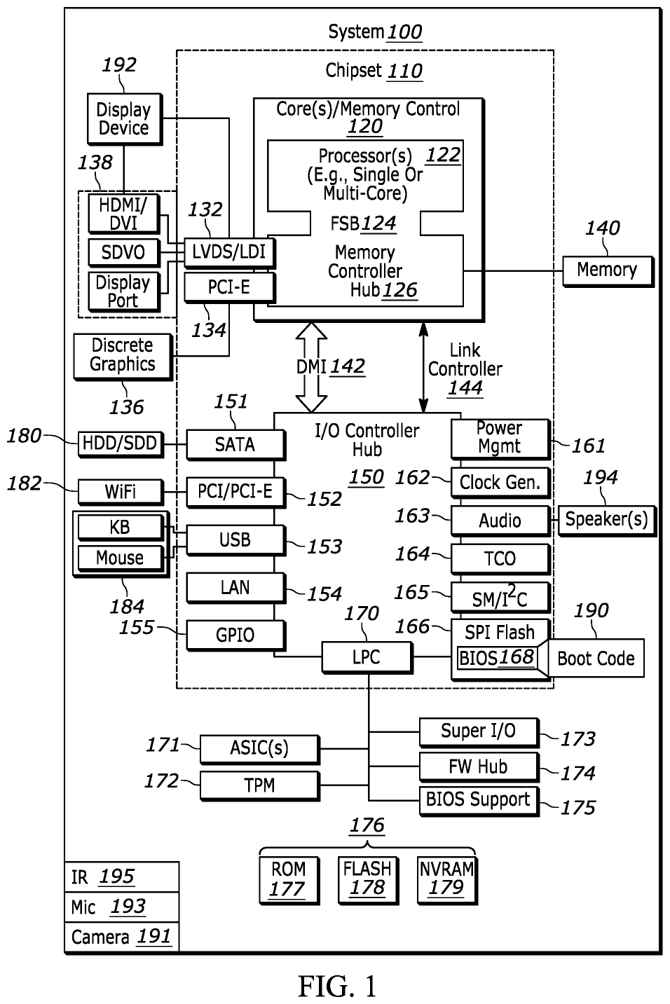

Now specifically in reference to FIG. 1, an example block diagram of an information handling system and/or computer system 100 is shown that is understood to have a housing for the components described below. Note that in some embodiments the system 100 may be a desktop computer system, such as one of the ThinkCentre® or ThinkPad® series of personal computers sold by Lenovo (US) Inc. of Morrisville, NC, or a workstation computer, such as the ThinkStation®, which are sold by Lenovo (US) Inc. of Morrisville, NC; however, as apparent from the description herein, a client device, a server or other machine in accordance with present principles may include other features or only some of the features of the system 100. Also, the system 100 may be, e.g., a game console such as XBOX®, and/or the system 100 may include a mobile communication device such as a mobile telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 includes a processor system 122 (e.g., one or more single core or multi-core processors, etc.) and a memory controller hub 126 that exchange information via a front side bus (FSB) 124. A processor system such as the system 122 may therefore include one or more processors acting independently or in concert with each other to execute an algorithm, whether those processors are in one device or more than one device. Additionally, as described herein, various components of the core and memory control group 120 may be integrated onto a single processor die, for example, to make a chip that supplants the “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled light emitting diode (LED) display or other video display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (×16) PCI-E port for an external PCI-E-based graphics card (including, e.g., one or more GPUs). An example system may include AGP or PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more universal serial bus (USB) interfaces 153, a local area network (LAN) interface 154 (more generally a network interface for communication over at least one network such as the Internet, a WAN, a LAN, a Bluetooth network using Bluetooth 5.0 communication, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes basic input/output system (BIOS) 168 and boot code 190. With respect to network connections, the I/O hub controller 150 may include integrated gigabit Ethernet controller lines multiplexed with a PCI-E interface port. Other network features may operate independent of a PCI-E interface. Example network connections include Wi-Fi as well as wide-area networks (WANs) such as 4G and 5G cellular networks.

The interfaces of the I/O hub controller 150 may provide for communication with various devices, networks, etc. For example, where used, the SATA interface 151 and/or PCI-E interface 152 provide for reading, writing or reading and writing information on one or more drives 180 such as HDDs, SSDs or a combination thereof, but in any case the drives 180 are understood to be, e.g., tangible computer readable storage mediums that are not transitory, propagating signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

The system 100 may also include one or more sensors. For example, the system 100 may include a camera 191, a microphone 193, and an infrared sensor (IR) 195. The camera 191 may gather one or more images and provide the images and related input (e.g., metadata like an image timestamp) to the processor system 122. The camera may be a thermal imaging camera, an infrared (IR) camera, a digital camera such as a webcam, a three-dimensional (3D) camera, and/or a camera otherwise integrated into the system 100 and controllable by the processor system 122 to gather still images and/or video.

The microphone 193 may provide input to the processor system 122 based on audio that is detected, such as via a user providing audible input to the microphone.

Though not shown, other types of sensors may also be included in the system 100 consistent with present principles, including inertial sensors that themselves may include a gyroscope that senses and/or measures the orientation of the system 100 and provides related input to the processor system 122, an accelerometer that senses acceleration and/or movement of the system 100 and provides related input to the processor system 122, and/or a magnetometer that senses and/or measures directional movement of the system 100 and provides related input to the processor system 122.

Another example sensor consistent with present principles may be a global positioning system (GPS) transceiver that is configured to communicate with satellites to receive/identify geographic position information and provide the geographic position information to the processor system 122. However, it is to be understood that another suitable position receiver other than a GPS receiver may be used in accordance with present principles to determine the location of the system 100 and provide that location data to one or more different apps.

Still further, other example sensors that may be used consistent with present principles include laser rangefinders, capacitive and resistive touch sensors, temperature sensors, other optical sensors, other proximity sensors, other sound sensors, etc.

It is to be understood that an example client device or other machine/computer may include fewer or more features than shown on the system 100 of FIG. 1. In any case, it is to be understood at least based on the foregoing that the system 100 is configured to undertake present principles.

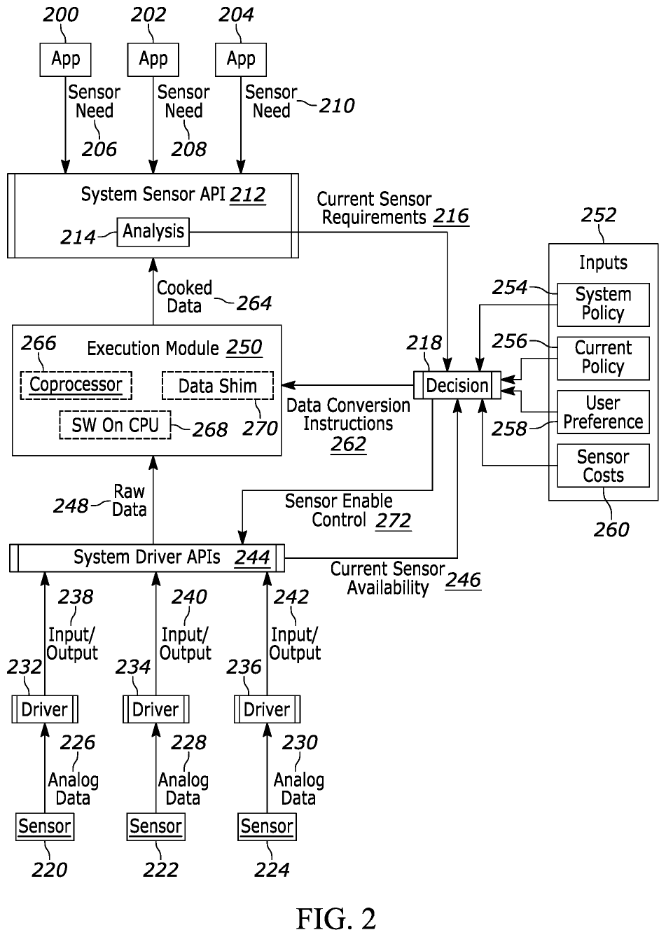

Now in reference to FIG. 2, a schematic diagram of example software architecture is shown to demonstrate devices and methods to choose, on a dynamic basis based on a variety of differently-weighted criteria, which sensor a computing system is to use for a given app-based task. As shown in FIG. 2, user mode apps 200, 202, 204 may output respective sensor data requests 206, 208, 210. The requests 206-210 may be provided to a system sensor application programming interface (API) 212 executing as part of a guest operating system (GOS) of the computing device and/or executing as part of a basic input/output system (BIOS) (or equivalent) of the computing device. Note that the apps 200-204 themselves may be a variety of different types, from biometric security apps to navigational assistance apps to social media apps to email apps and so on.

As also shown in FIG. 2, the API 212 may include an analysis module 214 executing logic consistent with present principles to determine current sensor requirements 216 of the computing system. Note that the current sensor requirements 216 themselves may be based on the requests 206-210, with the API 212 determining a cooked data type to satisfy each request and including the respective cooked data types in the requirements 216. The requirements 216 may then be fed into a decision module 218, as will be described in more detail in a moment.

However, reference is first made to the sensors 220, 222, 224 as also shown in FIG. 2. Each of the sensors 220-224 may be different from each other and may be established by a variety of different sensor types, including those described above in reference to FIG. 1 (e.g., camera, microphone, and IR sensor). The sensors 220-224 may provide respective analog data 226, 228, 230 to respective sensor drivers 232, 234, 236 for each of the sensors 220-224. The analog data 226-230 is one example of uncooked data consistent with present principles. The analog data 226-230 itself may be provided to the drivers 232-236 for the drivers 232-236 to respectively output digital I/O data 238, 240, 242. The digital I/O data 238-342 are also examples of uncooked data consistent with present principles.

As also shown in FIG. 2, the I/O data 238-242 may be provided to one or more system driver APIs 244 executing as part of the GOS or BIOS (or equivalent) of the computing device. The API(s) 244 may then execute logic consistent with present principles to, based on the I/O data 238-242, determine current sensor availability 246 from amongst the sensors 220-224. Thus, the API 244 may determine that one or more of the sensors 220-224 are turned off, are obstructed from sensing (e.g., for a camera or IR sensor), are inoperable, are malfunctioning, etc. Based on those determinations, the API 244 may then include a status indicator for each sensor in the current sensor availability data 246, with each status indicator indicating whether the respective sensor is available or not. The current sensor availability data may then be fed into the decision module 218. Also note that, as also shown in FIG. 2, the API(s) 244 may also output raw (uncooked) sensor data 248 to an execution module 250 that will be described in greater detail in a moment.

However, first describing the decision module 218 in more detail, in addition to receiving requirements 216 and data 246 as input, the module 218 may also receive one or more additional inputs 252. The additional inputs 252 may include one or more persistent system policy inputs 254. The persistent system policy inputs 254 may indicate a variety of different things configured by the computer's manufacturer, a system administrator, a technician, etc. The persistent system policy inputs 254 may indicate operative settings for persistent, immutable policies related to device operation, where those policies may have been set for a variety of reasons such as computing efficiency, security, and power consumption minimization.

The additional inputs 252 may also include one or more transient current system state inputs 256. The transient current system state inputs 256 may indicate a variety of things, including a current power state of the device. Example power states include powered on, powered off, awake/high-power mode, sleep mode, and hibernate mode. The transient current system state inputs 256 may also indicate current usage amount of one or more processors in the device's processor system, including the system's CPU, graphics processing unit, DSP, ISP, other co-processor or microprocessor, etc. The transient current system state inputs 256 may indicate still other things as well, such as current device temperature as sensed by a temperature sensor on the device, and current power usage as indicated by a battery management unit or power control circuitry on the device.

FIG. 2 also shows that user preference input 258 may also be provided as input 252 to the decision module 218. Example user preferences that may be indicated in the input 258 include user-indicated preferences to use one sensor 220-224 over another for a particular app or other device function. Other user preferences are also encompassed by present principles. The user's preferences may be received based on input to a graphical user interface (GUI), based on voice input, etc. Further note that while user preferences may be accommodated as much as possible in the sensor decision logic, the user preferences may be overridable by the persistent system policies 254 and/or transient system states 256 since the latter two may be weighted higher and take priority in the event of a conflict between which sensor to use based on which input. On that, further note that the persistent system policies 254 may themselves be weighted higher than, and take priority over, transient system states 256 in the event of a conflict over which sensor to use based on the different inputs.

FIG. 2 also shows computing resource metric inputs 260 as another type of input 252 that may be provided to the decision module 218. The computing resource metric inputs 260 may relate to the technical cost of using each of the different types of sensors 220-224. The metric inputs 260 may therefore indicate metrics of future expected power consumption and processor resource consumption of the device due to the operation of each of the different sensors 220-224 to meet one or more of the sensor data requests 206-210, with present principles further recognizing that a system policy 254 may be set to reduce power consumption and/or resource consumption as much as possible. The metric input 260 may also indicate expected heat generation by the device due to the operation of each of the different sensors 220-224 to meet one or more of the sensor data requests 206-210, with present principles further recognizing that a system policy 254 may be set to reduce heat generation as much as possible.

Additionally, in some examples the metric input 260 may also indicate metrics related to data time-to-delivery due to the operation of each of the different sensors 220-224 to meet one or more of the sensor data requests 206-210. Data time to delivery may include the expected processing time and transmission time to collect, receive, and convert uncooked sensor data into cooked data to then send to the app itself for use in conformance with one or more of the requests 206-210.

Based on the various inputs 216, 246, and 252, the decision module 218 may then execute logic consistent with present principles to dynamically select, based on the one or more sensors that are available as indicated in the availability data 246 and based on the sensor data requests 206-210 that are currently outstanding/in effect, one of the sensors 220-224 as a selected sensor from which to source uncooked data to meet the relevant sensor data request(s) 206-210. Again note that various system policies 254 and current system states 256 may take precedence over user preferences 258 when determining which sensor to select. Expected computing resource metrics/sensors costs 260 may also be considered as part of the logic of the module 218, depending on any policies set for optimizing energy savings and/or leaving certain processors, processor resources, and/or processor bandwidth available for other computing tasks. Minimizing external wireless transmissions and minimizing internal data traffic along data lines within the computing device may also be system policies that the decision module 218 uses to select one sensor over another.

Additionally, in some examples the decision module 218 may be programmed to evaluate the respective adequateness of the cooked data that would ultimately be provided to the relevant app for the relevant task using each of the different types of sensors/sensor inputs that are available. For example, different sensors may provide different granularities of data, may provide different sampling rates and response times for their data outputs, and may vary in other ways that might make cooked data from one available sensor more adequate than cooked data from another available sensor for a given app-based task. So in those cases, the sensor capable of providing the higher-quality cooked data may be selected for use. But in other cases, both types of available sensors might be adequate for providing cooked data for the relevant app-based task, and so the sensor with the lower technical cost of use may be selected instead.

As a specific example, if low-sampling rates are acceptable for the app-based task, and both a high sampling rate sensor and a low sampling rate sensor are available to satisfy the app's request, the decision module 218 may select the low sampling rate sensor for power savings according to the sensor costs 260 and/or system policies 254.

Therefore, as shown in FIG. 2, the decision module 218 may select a particular sensor and, based on the sensor's type, output data conversion instructions 262 to the execution module 250. The module 250 may be executed as part of the GOS or BIOS (or equivalent) of the computing device. Based on the conversion instructions 262, the module 250 may then cook the raw data 248 into cooked data 264 that is then provided to the system sensor API 212 by software 268 on the CPU and ultimately to one or more of the requesting apps 200-204. In one example implementation, the conversion instructions 262 may be used by a co-processor 266 or other type of hardware processor that executes one or more shims 270 consistent with the instructions 262 to perform dedicated data transformations to cook the raw uncooked data 248 into the cooked data 264. For example, the data shim(s) 270 may be executed cook the raw data and perform transformations to render the data in whatever cooked format is being requested by the relevant app (e.g., via a respective request 206-210).

Referring back to the decision module 218 for a moment, also note that FIG. 2 shows that the decision module 218 may also output one or more sensor enablement control signals 272 to the system driver API(s) 244. The signals 272 may indicate which sensors the drivers 232-236 are to turn on and/or operate to then provide the raw data 248 for cooking into the cooked data 264 for meeting the relevant app's request 206-210.

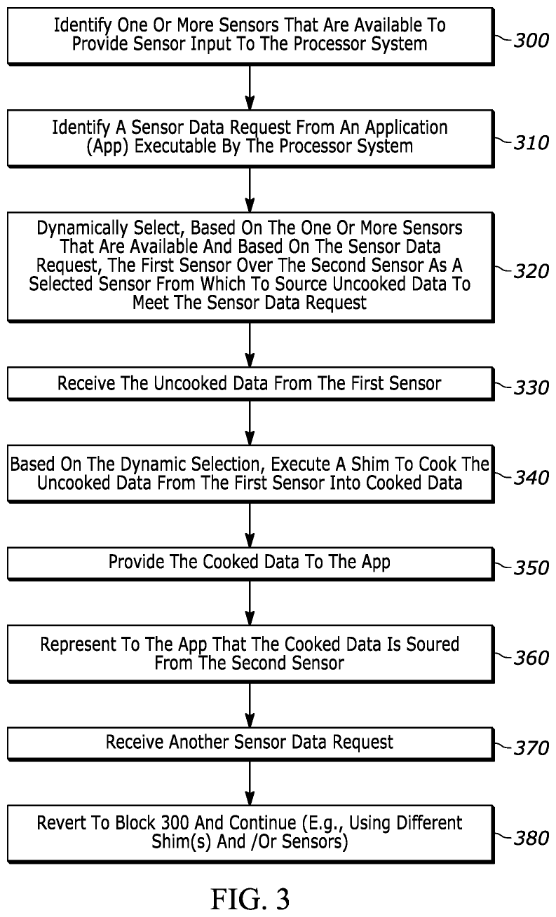

Continuing the detailed description in reference to FIG. 3, it shows example logic that may be executed by a device such as the system 100 in accordance with present principles and consistent with the description of FIG. 2 above. Note that while the logic of FIG. 3 is shown in flow chart format, other suitable logic may also be used.

Beginning at block 300, the device may identify one or more sensors that are available to provide sensor input to the processor system. The logic may then move to block 310 where the device may identify a sensor data request from an application (app) executable by the processor system. The logic may then progress to block 312 where the device may execute the module 218 to dynamically select, based on the one or more sensors that are available and based on the sensor data request, a first sensor over a second sensor as a selected sensor from which to source uncooked data to meet the sensor data request.

From block 320 the logic may then proceed to block 330. At block 330 the device may receive the uncooked data from the first sensor and then, at block 340 based on the dynamic selection, execute a shim to cook the uncooked data from the first sensor into cooked data. The logic of FIG. 3 may then proceed to block 350 where the device may provide the cooked data to the app. The logic may then move to block 360 where the device may represent to the app (e.g., through a source ID) that the cooked data is sourced from the second sensor so that the app does not even know it is getting data from a sensor other than the one that is has been programmed to use (the second sensor in this example).

From block 360 the logic may then proceed to block 370. At block 370 the device may receive another (second) sensor data request while, for example, the first cooked data from above is still being provided in a data stream to the first app to meet the first app's own (first) sensor data request. Therefore, at block 380 the device may revert back to block 300 and re-evaluate optimal sensor use based on the new sensor data request and one or more of the other inputs to the decision module 218 described above.

So as an example, for re-execution of the logic of FIG. 3 based on the second request, the device may, while providing the first cooked data to the first app, identify the second sensor data request from a second app. The device may then select, based on the sensors that are now currently available and based on the second sensor data request itself, a third sensor as a selected sensor from which to concurrently source both second uncooked data to meet the first (initial) sensor data request and third uncooked data to meet the second (subsequent) sensor data request. The device may then receive the second uncooked data from the third sensor and receive the third uncooked data from the third sensor (may be the same or different uncooked data). The device may then execute a second shim to cook the second uncooked data into second cooked data and execute a third shim to cook the third uncooked data into third cooked data. The device may then provide the second cooked data to the first app and provide the third cooked data to the second app. Note that the second shim may be the same as or different from the first shim. In certain specific examples, the first, second, and third shims may all be different from each other. Also note that the third sensor may be different from the first sensor and/or may be different from the second sensor.

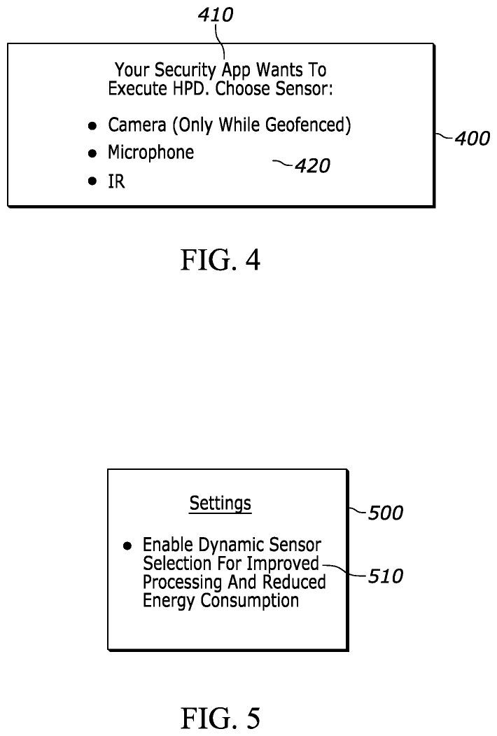

FIG. 4 shows an example graphical user interface (GUI) 400 that may be presented on a touch-enabled display of a computing device as part of dynamic selection of an available sensor to fulfill a specific app-based need consistent with present principles. The computing device may be a client device such as a laptop computer, desktop computer, smartphone, wearable device, headset, tablet computer, or other type of computing device.

Assume for this example that an antivirus or security app is requesting access to a camera on the device to execute human presence detection (HPD) as part of the digital security it provides, but the device has determined that one or more other sensors have a lower technical cost in terms of processing resources consumed and power consumed yet can still be used to satisfy the security app's request for HPD sensor data.

As such, the GUI 400 may include a prompt 410 indicating that the security app wants to execute HPD and instructing the end-user to choose a respective option 420 (each associated with a different sensor for the device to use). As shown, options 420 are respectively selectable to select a camera, a microphone, or an IR sensor per this example. Note here that the GUI 400 may also indicate a system policy that overrides whatever the end-user's selection ultimately ends up being. In this case, the system policy is that the camera may only be used while the device is within a secure, predetermined geofenced area (geolocation), and otherwise another sensor should be used instead.

FIG. 5 shows another example GUI 500. The GUI 500 may be a settings GUI that is presentable through a device OS or settings menu. The settings GUI 500 may include an option 510 that is selectable by the end-user to enable dynamic sensor selection for improved processing capability and reduced energy consumption. Thus, the option 510 may be selectable to set the device to, in the future, execute the processes described above in reference to FIGS. 2-4.

Moving on from FIG. 5 and providing another example to further illustrate present principles, a device may take as input the aggregate available sensors in the device as well as the aggregate momentary sensing requirements in the device to then match them to a preferred minimal component activation. The preference may be determined by finding an operational minimum, by user input, and/or by administration rule. If desired, the preference may be changed when the sensors, sensor requirements, and/or deterministic criteria change. Sensor data may thus be transformed to meet sensing requirements, where transformational computing load may be shifted to different parts of the computing device (different processors) to achieve a better match to the operational preference.

The computing device may incorporate the one or more sensors and the one or more consumers of sensing data (e.g., apps) to then activate only the needed sensors to meet the current sensing requirements. The device may include both a CPU and a co-processor, and may shift sensor data processing between the CPU or co-processor to better meet current sensing requirements. The device may convert sensor formats to formats used by sensor consumers on an ad-hoc basis to meet changes in sensing requirements. The system APIs may then perform sensor impersonation so what sensor the app thinks it is using might not be the actual sensor being used, with the system API consuming data and pretending to be the app's preferred sensor.

Accordingly, present principles allow various apps to use sensors that they might not otherwise know how to process, using shims to convert the data to the requirements of the app. Present principles may thus expand the applicability of use of certain sensors to certain apps that wouldn't otherwise be able to use those sensors.

Present principles may therefore provide the technical device capability to shift sensor data processing from CPU to a coprocessor, adapt to changing sensor consumer requirements, dynamically enable and disable sensors, and change sensor requirements based on user preference and current device state.

Components included in one embodiment can be used in other embodiments in any appropriate combination. For example, any of the various components described herein and/or depicted in the Figures may be combined, interchanged or excluded from other embodiments.

It is to be understood that whilst present principals have been described with reference to some example embodiments, these are not intended to be limiting, and that various alternative arrangements may be used to implement the subject matter claimed herein. Accordingly, while particular techniques and devices are herein shown and described in detail, it is to be understood that the subject matter which is encompassed by the present application is limited only by the claims.

What is claimed is:

1. A device, comprising:
a processor system;
a first sensor of a first sensor type;
a second sensor of a second sensor type, the second sensor type being different from the first sensor type; and
storage accessible to the processor system and comprising instructions executable by the processor system to:
identify one or more sensors that are available to provide sensor input to the processor system;
identify a sensor data request from an application (app) executable by the processor system;
dynamically select, based on the one or more sensors that are available and based on the sensor data request, the first sensor over the second sensor as a selected sensor from which to source first data for meeting the sensor data request;
provide second data to the app and also represent to the app that the second data is sourced from the second sensor, the second data being generated based on the first data.

2. The device of claim 1, wherein the instructions are executable to:
receive the first data from the first sensor, the first data being uncooked data;
based on the dynamic selection, execute a shim to cook the uncooked data from the first sensor into cooked data, the second data being the cooked data; and
provide the cooked data to the app and also represent to the app that the cooked data is sourced from the second sensor

3. The device of claim 1, wherein the dynamic selection is based on one or more persistent system policies.

4. The device of claim 3, wherein the dynamic selection is also based on one or more transient system states.

5. The device of claim 4, wherein the one or more transient system states comprise a current power state of the device.

6. The device of claim 4, wherein the one or more transient system states comprise a current usage of one or more processors in the processor system.

7. The device of claim 4, wherein the dynamic selection is also based on one or more user preferences accessible to the device.

8. The device of claim 7, wherein the user preferences are overridable by the one or more persistent system policies and/or the one or more transient system states.

9. The device of claim 4, wherein the dynamic selection is based on:
computing resource metrics expected based on operation of the first sensor to meet the sensor data request, and computing resource metrics expected based on operation of the second sensor to meet the sensor data request.

10. The device of claim 9, wherein the computing resource metrics relate to expected power to be consumed by each of the first sensor and the second sensor to meet the sensor data request.

11. The device of claim 9, wherein the computing resource metrics relate to expected processor resources to be consumed by each of the first sensor and the second sensor to meet the sensor data request.

12. The device of claim 9, wherein the computing resource metrics relate to data time-to-delivery using each of the first sensor and the second sensor to meet the sensor data request.

13. The device of claim 1, wherein the dynamic selection is based on the combination of data cooking steps that best achieves the plurality of sensor data requests received from applications.

14. A method, comprising:
identifying one or more sensors that are available to provide sensor input to a processor system;
identifying a sensor data request from an application (app) executable by the processor system;
using the processor system to select, based on the one or more sensors that are available and based on the sensor data request, a first sensor as a selected sensor from which to source first data for meeting the sensor data request;
using the processor system to provide second data to the app, the second data being generated based on the first data.

15. The method of claim 14, comprising:
receiving, at the processor system, the uncooked data from the first sensor, the uncooked data establishing the first data;
based on the selection, using the processor system to execute a shim to cook the uncooked data from the first sensor into cooked data, the cooked data establishing the second data; and
using the processor system to provide the cooked data to the app.

16. The method of claim 15, comprising:
based on one or more criteria for the selection, selecting one of a first processor and a second processor to cook the uncooked data, the first and second processors being processors of different processor types.

17. The method of claim 14, wherein the app is a first app, wherein the sensor data request is a first sensor data request, wherein the uncooked data is first uncooked data, wherein the cooked data is first cooked data, wherein the shim is a first shim, and wherein the method further comprises:
while providing the first cooked data to the first app, identifying a second sensor data request from a second app executable by the processor system;
using the processor system to select, based on the one or more sensors that are available and based on the second sensor data request, a third sensor as a selected sensor from which to source second uncooked data to meet the first sensor data request and from which to concurrently source third uncooked data to meet the second sensor data request;
receiving, at the processor system, the second uncooked data from the third sensor;
receiving, at the processor system, the third uncooked data from the third sensor;
using the processor system to execute a second shim to cook the second uncooked data from the third sensor into second cooked data;
using the processor system to execute a third shim to cook the third uncooked data from the third sensor into third cooked data; and
using the processor system to provide the second cooked data to the first app and to provide the third cooked data to the second app.

18. The method of claim 16, wherein the second shim is different from first shim.

19. The method of claim 16, wherein the first, second, and third shims are different from each other, and wherein the third sensor is different from the first sensor and is different from the second sensor.

20. At least one computer readable storage medium (CRSM) that is not a transitory signal, the at least one CRSM comprising instructions executable by a processor system to:
identify one or more sensors that are available to provide sensor input to the processor system;
identify a sensor data request from an application (app) executable by the processor system;
select, based on the one or more sensors that are available and based on the sensor data request, a first sensor as a selected sensor from which to source first data for meeting the sensor data request;
and
provide second data to the app, the second data being generated based on the first data.
